(19) United States
(12) Patent Application Publication
(10) Pub. No.: US 2023/0196924 A1
(43) Pub. Date: Jun. 22, 2023

(54) Cognitive Wireless Vehicular Emergency Response System for first responders

(71) Applicant: Prathamesh Khedekar, Downers Grove, IL (US)

(72) Inventor: Prathamesh Khedekar, Downers Grove, IL (US)

(21) Appl. No.: 17/557,082

(22) Filed: Dec. 21, 2021

(51) Int. Cl. G08G 5/00; B64C 39/02

(52) U.S. Cl. CPC G08G 5/0056; G08G 5/006; G08G 5/0069; B64C 39/024; B64C 2201/122

(57) ABSTRACT

The present invention discloses an advanced emergency response system that minimizes physical risk to the first responder and yet allows them to maintain national safety and security within the country. The apparatus involves receiving alerts through the dispatch system located in the first responder car. The first responder car, upon receiving an alert, is dispatched to the appropriate address and is parked within a safe distance from the emergency location. The first responders then dispatch the autonomous rover from their vehicle using a vehicle dashboard. The rover is equipped with cameras, an object detection system, location sensors, and it shares live feeds for situational awareness with the public safety agencies and first responders. It also enables real-time bidirectional communication for first responders, public safety agents and allows them to communicate with the suspects and the victims located at the hazard/emergency site. The system also uses Artificial Intelligence (AI) algorithms to detect safety and security anomalies associated with the emergency situation in the field and shares this information with the public safety agents. If the suspect decides to run and take off, this system allows the first responders to launch a swarm of drones using cognitive vehicle dashboard that keep track of the suspect and provide situational awareness to the first responders and the public safety agents. All components involved in this system use Public Safety Grade FCC Band 14 Telecom Network for wireless communication dedicated to public safety agents and this network provides mission-critical reliability and security. The assembly is easy to install, safe to use, and suitable for all public safety agents and first responders.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to a security system and, more particularly, aims to provide a secure, reliable, mission-critical grade cognitive wireless emergency response system for first responders to tackle emergency situations such as hot pursuit, violence, protests, riots, natural disasters by minimizing physical risk and enabling an efficient form of communication in the field.

### Description of the Related Art

In recent years, emergency response systems have come into widespread use in the United States. If not already in existence, emergency response systems are likely to become widely used in other countries of the world. As a matter of fact, several Western European countries already have emergency response systems in place. The number and variety of such devices also reflect that no single device has been found satisfactory enough to prevent or assist individuals in the case of an emergency.

There are many inventions that have been registered in prior art related to the emergency response system. For instance, a Response system with emergency response equipment locator bearing US patent 2,017,0273116A1 is issued to Zoll Medical Corp. This document relates to systems and techniques for providing response to emergency situations, such as traffic accidents, cardiac arrest, or other medical emergencies. The systems and techniques include methods for identifying and accessing emergency response equipment during a medical emergency.

Personal emergency response communications system is a U.S. Pat. No. 5,305,370A issued to Lloyd Kearns, Petersen David E. The patent discusses a personal emergency response system in which a hand-held portable transmitter (12) activates a base unit (14) interfaced with the telephone network (16) to dial 9-1-1 and permit direct communications with the operator (18) at the public safety answering point even though the user (10) is unable to reach a telephone (36). The transmitter (12) activates the base unit (14) as well as optional remote units (48) located throughout the users residence or place of business. The base unit (14) and remote units (48) include speaker-phone communication capabilities that permit two-way communications between the user (10) and the 9-1-1 system operator (18).

A system and method of automated gunshot emergency response system bearing US patent 2,018,0158305A1 is issued to Onalert Guardian Systems Inc. The patent relates to a threat sensing system is provided including, in some aspects, a plurality of threat sensing devices distributed throughout a school or facility, with each of the threat sensing devices comprising one or more acoustic sensors, one or more gas sensors, and a communication circuit or communication device configured to output sensor data to a system gateway. The system gateway is configured to receive and process the sensor data output from the threat sensing devices and determine whether the processed sensor data corresponds to one of a predetermined plurality of known threats (e.g., a gunshot) and, if so, to communicate the existence of the threat, the processed sensor information, and/or predetermined messaging information to one or more recipient devices (e.g., first responders, dispatchers).

Another patent 1,05,09414B1 on using emergency response system (EMS) vehicle telematics data to reduce accident risk is issued to State Farm Mutual Automobile Insurance Co. The patent relates to a computer system configured to use emergency response system (EMS) vehicle telematics data to reduce the risk of accidents may be configured to (1) receive, when the EMS vehicle is en route to an emergency location, the EMS vehicle telematics data associated with the EMS vehicle and including GPS location, speed, route, heading, acceleration, and/or lane data; (2) determine that a current route of an autonomous vehicle will interfere with the route of the EMS vehicle; (3) determine an alternate route for the autonomous vehicle to avoid interfering with the route of the EMS vehicle, and (4) direct the autonomous vehicle to (i) travel along the alternate route or (ii) pull over to a side of a road on the current route to allow the EMS vehicle to pass unimpeded. Insurance discounts may be generated based upon the risk mitigation or prevention functionality.

Another patent on the System and method for initiating an emergency response 1,004,4857B2A is issued to Shelter Inc. The invention relates to system and method for initiating a personal emergency response is disclosed. The method can include receiving an emergency communication via a virtual assistant, spoken by a user, and an urgent situation or an emergency situation. The emergency communication can be processed to determine the nature of the emergency communication and translate the emergency communication into an emergency data message having a digital representation of information related to the emergency communication. If the emergency communication indicates an urgent situation, the system can contact an emergency contact based on stored user preferences. If the emergency communication indicates an emergency situation, then the system can aid in the dispatch of emergency services and provide information about the user to provide a measured response to the emergency communication.

Another Personal emergency response system with predictive emergency dispatch risk assessment 10796560B2 is issued to Koninklijke Philips NV. The system relates to a Personal Emergency Response System (PERS) service, activation of a wearable call device by a PERS client causes a speakerphone console to connect with a PERS call center to enable the PERS client to converse with a call center operator while a PERS client profile is retrieved from a PERS database and displayed on a display component at the PERS call center. From the profile, values of a set of features are generated for the PERS client. An emergency dispatch risk prediction or other risk prediction is computed over a future time horizon for the PERS client based on the generated values of the set of features and is displayed on the display component. The risk prediction may be wirelessly sent to a mobile device for display on the mobile device.

Emergency response personnel automated accountability system is a U.S. Pat. No. 7,091,852B2 issued to Tri Sentinel Inc. The patent discloses an emergency response personnel automated accountability system, also referred to as a Firefighter Automated Accountability System (FAAS), is provided that supports automatic tracking of and limited communications among first responders, including fire, police, emergency medical service, and safety personnel. The FAAS increases situational awareness and safety of first responder personnel by automatically providing position information as well as other sensor information. Components of the FAAS integrate wireless mesh networks with positioning and communication systems to support real-time tracking of and communications with emergency response personnel. The FAAS incident awareness system provides position and time information via Global Positioning System (GPS) and/or other positioning systems and processed data from sensors to provide enhanced communications, command, and control capabilities to the first responders and incident command at the incident scene.

A U.S. Pat. No. 7,395,151B2 is a system and method for knowledge-based emergency response issued to O'neill Dennis M, Guillermo Francisco Arango. The system discloses a knowledge-based system and method for establishing and managing routes for emergency vehicles. The knowledge-based system and method uses a knowledge base having information useful in establishing and managing routes for emergency vehicles, including information on intersections, road segments connecting intersections, expected travel time along the road segments, and dynamic factors that influence traffic flow, and a database for storing routes designed using the information useful in establishing and managing routes. The knowledge-based system also consists of one or more software modules operable to retrieve information from the knowledge base and to perform operations such as designing routes between locations involved in emergency response, selecting between such routes, and modifying such routes, all using the information in the knowledge base.

A US patent 2,005,026,7651A1, is a system and method for knowledge-based emergency response issued to Guillermo Arango, O'neill Dennis M. The system discloses a knowledge-based system and method for establishing and managing routes for emergency vehicles. The knowledge-based system and method uses a knowledge base having information useful in establishing and managing routes for emergency vehicles including information on intersections, road segments connecting intersections, expected travel time along the road segments, and dynamic factors that influence traffic flow, and a database for storing routes designed using the information useful in establishing and managing routes. The knowledge-based system also consists of one or more software modules operable to retrieve information from the knowledge base and to perform operations such as designing routes between locations involved in emergency response, selecting between such routes, and modifying such routes, all using information in the knowledge base.

A U.S. Pat. No. 8,866,606B1 is a system and method for automated personal emergency responses issued to Rockwilli RMR LLC. The patent discloses a subscriber device for use in an automated personal emergency response system implemented as a conference bridge on a remote computing network. The device, intended to be worn as a pendant, wristband, or in another wearable configuration, includes a high-resolution color display for signaling a user of the subscriber device with notifications, arrows for directional guidance, and/or other status messages. The device also includes microphones and speakers for enabling a teleconference between a user of the subscriber device in need of assistance and parties joined to the teleconference via the automated personal emergency response system. The user of the subscriber device may initiate the call for assistance and teleconference via a press of a single button on the device; alternatively, accelerometers in the device may detect a fall and automatically initiate the call. The device can receive medical telemetry and provide it to conference participants and perform home automation tasks.

Another patent on Managing emergency response services using mobile communication devices bearing U.S. Pat. No. 8,576,066B2 is issued to Ecobee Inc. The invention embodiments manage emergency response services. An emergency event is determined to have occurred. A set of civilian responders currently available to respond to the emergency event is selected from a plurality of civilian responders in response to determining that the emergency event has occurred. Each civilian responder in the set of civilian responders is associated with at least one wireless communication device. The set of civilian responders is notified that the emergency event has occurred. A set of emergency event information associated with the emergency event is transmitted to at least one wireless communication device associated with each civilian responder in the set of civilian responders.

There are multiple solutions that have been presented in prior art. However, these solutions are limited and restricted to their conventional systems. In general, an emergency request related to an emergency situation is best addressed when measures are taken in a timely manner such that the emergency request is responded to and addressed by a respondent as quickly as possible by minimizing the physical risk involved in such situations. In other words, a short response time to an emergency situation and physical risk mitigation is of utmost importance to resolving the emergency situation successfully. For example, a fire department, a police department, a ranger patrol unit, a health care provider, a roadside assistance agency, a water damage specialist, or other emergency services would strive to dispatch personnel, such as a rapid response team (RRT) or emergency response team (ERT) thereof, to arrive at a scene of an emergency in the shortest interval of time possible. However, a short response time may not always be achievable due to various constraints, such as a distance between a location of an emergency service provider and the scene of an emergency, or a physical condition of a distressed person involved in the emergency.

It has to be noted that the current invention proposes an advancement in providing an advanced Emergency response system for first responders. A cognitive wireless emergency response system is presented in the form of a secure, reliable, mission-critical emergency response system for first responders to tackle emergency situations on real-time basis and act according to emergency events like criminal activities, physical abuse, sexual abuse, robbery/shoplifting, arson, flooding, drowning, fall detection, mental issues detection, etc.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract as a whole.

The primary desirable object of the present invention is to provide a novel and improved form of emergency response system for first responders that enables an instant and efficient form of communication.

It is also the primary objective of the invention to provide a secure, reliable, mission-critical grade cognitive wireless emergency response system for first responders to tackle emergency situations such as hot pursuit, violence, protests, riots, natural disasters by minimizing physical risk and enabling an efficient form of communication in the field.

It is also the objective of the system, to minimize physical risk involved in emergency situation by integrating following 5 key components —cognitive mission-critical client module, mission-critical public-safety grade autonomous rover, public-safety grade telecom network, cognitive mission-critical drone, and cognitive mission-critical servers.

It is another objective of the invention to provide a smart system where the cognitive mission-critical module client will be installed in each first responder vehicle, allowing the first responders to receive and share real-time information about an incident with other public safety agents while they are in field.

It is also the objective of the invention to provide a mission-critical cognitive autonomous rover that will use sensors such as LiDARs, 3d mapping devices, and gyro for positioning, localization, and navigation. The cognitive autonomous rover will also be equipped with cameras and a bidirectional video communication module that will allow the first responders to communicate with the suspects and victims in field remotely thereby minimizing physical risk involved in such emergencies.

It is also the objective of the invention to provide a mission-critical cognitive autonomous aerial agents (drone) that which will use sensors such as LiDARs, 3d mapping devices, and gyro for positioning, localization, and navigation. The cognitive autonomous aerial agents will be used by the first responders to track the suspects while pursuing them via their mission-critical first responder vehicle.

It is the most crucial objective of the invention to provide a mission-critical public safety grade telecom device that will operate in FCC Public Safety Band 14 and will allow the mission-critical module client installed in the first responder vehicle to share all the information captured in the field with the mission-critical grade public safety servers over a public-safety grade telecom network.

It is also the system's objective to provide mission-critical servers that will act as a centralized point of communication and allow first responders to communicate with other first responders within the county/city and seek their advice.

It is further the objective of the invention to provide an emergency response system that offers exact mapping and necessary information of those who need help and who can help through either international distress signal recognition or emergency event recognition.

It is also the objective of the invention to provide a mission-critical public-safety grade telecom network that will serve as a reliable and secure channel and will connect the client module located in the first responder vehicle to the mission-critical servers hosted in physical geo-redundant data centers.

It is also the objective of the invention to provide a smart assembly that provides enhanced reaction time in case of any emergency and doesn't require user input.

A further object is to provide an assembly that will allow public safety agencies to provide higher-quality service for mission-critical emergency communication using dedicated telecom APN and QoS priority parameters.

Still, yet another object of the present invention is to provide a new and improved emergency response system which provides in the apparatuses and methods of the prior art some of the advantages thereof while simultaneously overcoming some of the disadvantages normally associated therewith.

Other aspects, advantages, and novel features of the present invention will become apparent from the detailed description of the invention when considered in conjunction with the accompanying drawings.

This Summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where reference numerals refer to identical or functionally similar elements throughout the separate views, together with the detailed description below, are incorporated by reference and form a part of the specification. That also serve to further illustrate embodiments of concepts that include the claimed invention and explain various principles and advantages of those embodiments.

FIG. 1 shows the System Components associated with the Cognitive First Responder Vehicle (First Responder Vehicle, Cognitive Mission-Critical Autonomous Rover, Cognitive Mission-Critical Autonomous Aerial Agents (drones), Cognitive Mission-Critical Client Module, Mission-Critical Public Safety Grade Telecom Router, First Responders) as per perspective embodiments of the invention.

FIG. 2 shows the overall system components that include Cognitive First Responder Vehicle, Cognitive Mission-Critical Autonomous Aerial Agents, Cognitive Mission-Critical Autonomous Rover, Mission-Critical Public Safety Grade FCC Band 14 Telecom Radio Network, Geo-redundant Public Safety Grade core servers, and Cognitive Mission-Critical Dashboard for Public Safety Agencies as per perspective embodiments of the invention.

FIG. 3 shows a vehicle equipped with a cognitive vehicle dashboard for first responders as per perspective embodiments of the invention. This dashboard allows the first responders to manage the aerial agents and the rover, and thus it enables reliable and safe communication channel with the suspects and the victims.

FIG. 4 shows a live mission-critical operation performed by the first responders using the cognitive vehicle dashboard, mission-critical telecom network, and cognitive feeds generated by the rover and aerial agents as per perspective embodiments of the invention.

Skilled artisans will appreciate that elements in the figures have been illustrated for simplicity and clarity and not necessarily drawn to scale. For example, some of the dimensions of the elements in the figures may be exaggerated relative to other elements to help improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure, or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced wireless vehicular emergency response system that enables first responders to address emergencies safely and efficiently by minimizing the physical risk involved in such situations.

The assembly, as per illustrative embodiment, discloses a new process of dealing with emergency situations through a smart methodology. The proposed invention can be used by anyone in need to receive emergency assistant in a very short time. And it can also be used by crowd-tasking responders to help in emergency or disaster situations.

The assembly could also be used in providing real-time information about disasters and crises. Furthermore, it can be used as a source of data analytics about emergencies and a database for all working solutions.

This system aims to provide a secure, reliable, mission-critical grade cognitive wireless emergency response system for first responders to tackle emergency situations such as hot pursuit, violence, protests, riots, natural disasters by minimizing physical risk and enabling an efficient form of communication in the field.

This system includes 5 key components—cognitive mission-critical client module, mission-critical public-safety grade autonomous rover, public-safety grade telecom network, cognitive mission-critical aerial agents (drone), and cognitive mission-critical servers. The cognitive mission-critical module client will be installed in each first responder vehicle—cars, trucks, etc. This client will be responsible for providing real-time information about an incident to the first responders while they are in the field. This client will include a cognitive digital communication module and will enable functionality such as secure voiced and text-based digital communication. The client will also include a cognitive wireless communication module that will explore other first responder vehicles within a certain radius in 3d space in an autonomous fashion and will establish a secure broadcast communication medium for all the parties involved in the communication over a private LTE network.

The second component, as per its further embodiments, will be a mission-critical autonomous rover that will be installed in the mission-critical first responder vehicle and will be dispatched by the first responder while they are in the vehicle. The first responders will be able to operate this mission-critical cognitive rover in both manual and autonomous mode. Using the manual mode, they will be able to drive it using a joystick device installed in the vehicle, and using the autonomous mode; they will be able to add points on the map displayed on the mission-critical module client dashboard. The mission-critical cognitive autonomous rover will use sensors such as LiDARs, 3d mapping devices, and gyro for positioning, localization, and navigation. In addition to navigation, this rover will also be enabled with a computing module and high-definition cameras that will relay the live feeds to the cognitive object detection system installed on the computing module. This object detection system will scan for information such as the presence of a weapon, type of weapon, distance from the suspect, emotions of the suspect, sound levels of the suspect, eye and hand movements, and will provide predictions of the next step to the first responder. The first responders present in their vehicle will be able to use this data with real-time cam feeds and will be able to communicate and negotiate a safety measure with the suspect and victims without endangering their lives.

In the event the suspect decides to run away from the spot, the public safety agents can dispatch a cognitive rover and track the location of the suspect while pursuing them via their mission-critical car. The cognitive aerial agent (drone) will also be equipped with the sensors such as LiDAR, 3d mapping device, gyro, GPS for positioning, localization, and navigation. In addition to this, it will also be equipped with a mission-critical public safety grade telecom device that will allow it to communicate with the mission-critical module client installed in the first responder vehicle over a public-safety grade telecom network. Autonomous navigation, suspect chase, video communication, and cognitive situational awareness are some of the services that will be provided to the first responders using the cognitive drone and rover.

The 4th component, as per its further embodiments, is a mission-critical server, that will act as a centralized point of communication and will allow first responders to communicate with other first responders within the county/city and seek their advice. These servers will also broadcast the stream received from the emergency site to multiple local public safety agencies so they can analyze the scenario and prepare additional onsite support to mitigate the risk and resolve the incident. These servers will store all the data and findings from the situation, and this information will later be used to study the incident and optimize first responder response for future scenarios.

The 5th component, as per its additional embodiments, is the mission-critical public-safety grade telecom network that will serve as a channel and will connect this client to the mission-critical servers hosted in physical geo-redundant data centers. It will allow public safety agencies to provide higher-quality service for mission-critical emergency communication using dedicated telecom APN and QoS priority parameters. This will ensure that these modes of communication will be carried on dedicated and secure communication channels that operates in FCC Telecom Band 14 and will not be overwhelmed like the public mode of communication that gets overwhelmed in case of major national emergencies.

Thus, this system will enable mission-critical grade cognitive mode of communication using autonomous rover and drone dispatch system, object detection system, secure telecom networks thereby minimizing the physical risk to public safety agents and ensuring safety and security across the nation.

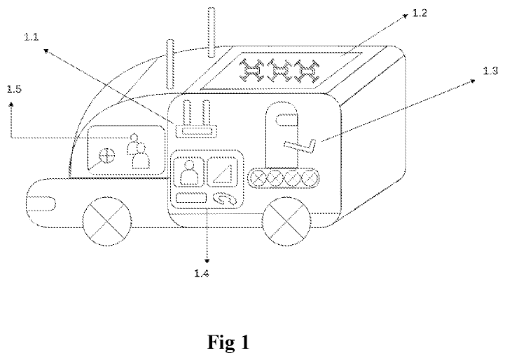

By looking at multiple diagrams, process flow can be understood of the proposed system. FIG. 1 shows the System Components associated with the Cognitive First Responder Vehicle (First Responder Vehicle, Cognitive Mission-Critical Autonomous Rover, Cognitive Mission-Critical Autonomous Aerial Agents (drones), Cognitive Mission-Critical Client Module, Mission-Critical Public Safety Grade Telecom Router, First Responders) as per perspective embodiments of the invention. The system involves Mission-Critical Public Safety Grade Telecom Router (1.1), Cognitive mission-critical autonomous aerial agents (1.2), Cognitive mission-critical autonomous rover (1.3), Cognitive mission-critical client module (1.4), and First responder (1.5) in the vehicle.

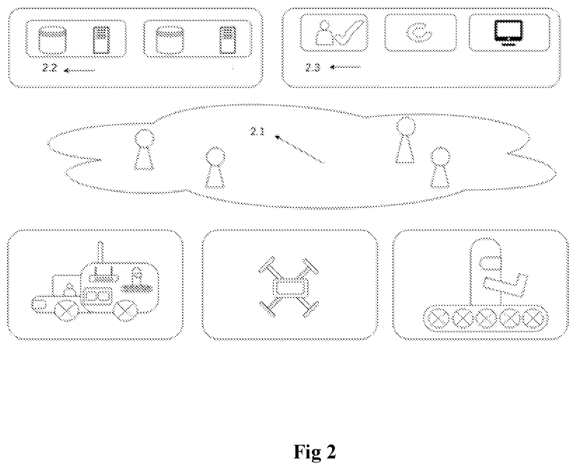

FIG. 2 shows a vehicle equipped with a cognitive module dashboard which includes mission-critical public safety grade telecom radio network (2.1), mission-critical public safety grade geo-redundant core servers (2.2), cognitive mission-critical dashboard for public safety agencies (2.3), cognitive first responder vehicle (2.4), cognitive mission-critical autonomous aerial agents (2.5) and cognitive mission-critical autonomous rover (2.6).

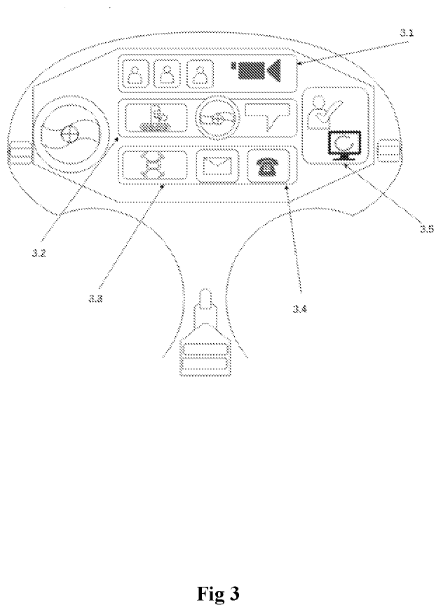

FIG. 3 shows vehicle equipped with cognitive rover and drone, which includes real-time feeds from the rover and aerial agents (3.1), Rover dispatch module (3.2), Aerial agent dispatch module (3.3), Rover bidirectional video and text communication module (3.4) and cognitive module for anomaly and object detection (3.5).

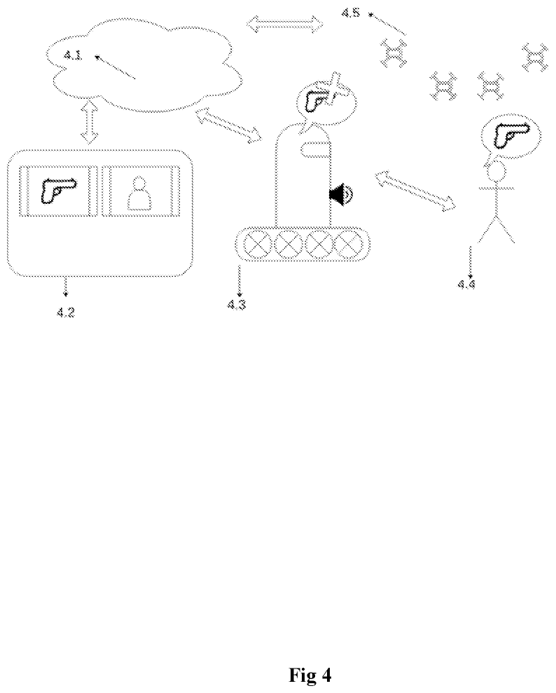

FIG. 4 shows a live mission-critical operation performed by the first responders using the cognitive vehicle dashboard, mission-critical telecom network, and cognitive feeds generated by the rover and aerial agents as per perspective embodiments of the invention. The components involved in the live security operation include mission-critical public safety telecom network (4.1), cognitive vehicle dashboard feeds generated by the object detection module located on the rover and the aerial agents (4.2), the autonomous rover used by public safety agents for communication and situational awareness (4.3), suspect carrying weapons (4.4) and cognitive aerial agents for suspect tracking and situational awareness (4.5).

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, subject matter lies in less than all features of a single disclosed embodiment. Thus, the following claims are hereby incorporated into the Detailed Description, with each claim standing on its own as a separately claimed subject matter.

I: An application developed on the idea of an emergency response system utilizing the advanced technologies, enabling the first responders to provide prompt, safe and efficient response.

II: An intelligent emergency response system enabled with artificial intelligence where:
according to claim II, where the dispatch system receives an alert;
according to claim II, where first responder vehicles equipped with rovers and drones and are dispatched to the address;
according to claim II, where first responder parks car within the safety distance from the location of suspect/hazard;
according to claim II, where the first responder dispatches the rover;
according to claim II, where rover relays live feeds, intelligence to the first responder;
according to claim II, where first responders use cognitive vehicle dashboard to manage safety and security operation and to control rovers and aerial agents (drones);
according to claim II, where first responders communicate with the suspect through the rover and convince them to drop all weapons and to surrender;
according to claim II, where first responders also communicate with local public safety agencies using the wireless public safety grade FCC Band 14 communication module installed in the first responder vehicle;
according to claim II, where first responders negotiate safety measures with the suspect using the bidirectional communication functionality enabled by the rover and the cognitive vehicle dashboard;
according to claim II, where the information captured by the autonomous rover and the aerial agents is stored in the mission-critical geo-redundant core servers that provide higher reliability, availability and security for mission-critical operations;
according to claim II, wherein case the suspect decides to run and takeoff, the first responders launch a swarm of drones using cognitive vehicle dashboard that keep track of the suspect and provide situational awareness to the first responders; and
according to claim II, where the first responders retrack the rover and track the suspect's location using the swarm of cognitive aerial agents (drones).
